(19) United States
(12) Patent Application Publication
(10) Pub. No.: US 2003/0224647 A1
(43) Pub. Date: Dec. 4, 2003

(54) Housing structure of a burn-in socket

(75) Inventors: Teng-Sheng Hung, Chuang City (TW); Chi-Chang Chen, Lu-Chu Hsiang (TW)

Correspondence Address: BRUCE H. TROXELL, SUITE 1404, 5205 LEESBURG PIKE, FALLS CHURCH, VA, 22041, US

(73) Assignee: Speed Tech Corp.

(21) Appl. No.: 10/154,811

(22) Filed: May 28, 2002

(51) Int. Cl. H01R 13/62

(52) U.S. Cl. 439/331

(57) ABSTRACT

Housing structure of a burn-in socket. Multiple densely and parallelly arranged core pins are respectively disposed the mold of the housing on two sides thereof. At least one filling member is plugged between the core pins. After molded, two lateral sides of the housing are formed with multiple densely arranged terminal channels separated from each other by ribs. A middle portion of each rib is formed with at least one notch. By means of plugging the filling member between the core pins, the rigidity of the core pins is enhanced to prevent the core pins from being bent and deformed so as to ensure precise width of the terminal channels and thickness of the ribs and thus ensure good quality of the product. Moreover, the flowability of the injected material flowing into the fine gaps between the core pins can be enhanced. Also, the injection pressure can be reduced to minimize damage of the mold.

### BACKGROUND OF THE INVENTION

The present invention is related to a housing structure of a burn-in socket. When molded, the housing is prevented from deforming. In addition, the ribs between the terminal channels have even thickness so as to ensure good quality of the product and lower manufacturing cost.

A burn-in socket is used to test an IC. It is a trend to minimize the volume of the burn-in socket. Accordingly, the terminals of the socket are more and more densely arranged so that the pitch between the terminals is smaller and smaller. As a result, it is harder and harder to process and manufacture the parts of the burn-in socket. Especially, when injectionmolding thehousing of the burn-in socket, it is very hard to keep the respective parts of the housing having precise dimensions.

FIG. 1 shows the housing of a conventional burn-in socket. Two lateral sides of the housing 4 are formed with multiple densely arranged terminal channels 41 separated by ribs 42. When injection molding the housing 4, the terminal channels 41 are formed in such amanner that multiple parallel core pins are extended into themold. After the material is injected and molded, the terminal channels 41 are formed in the positions of the core pins. The gaps between the core pins naturally form the ribs 42 after molded. Following the reduction of the volume of the burn-in socket, the width of the terminal channels 41 and the thickness of the ribs 42 are minimized. Accordingly, the core pins are quite slender and thin. A shortcoming exists in such structure as follows:

The core pins are densely arranged so that when molding the housing, the injected material can hardly flow through the gap between the core pins. Therefore, housing is often poorly molded and deforms. As a result, the production efficiency is lowered and the manufacturing cost is increased.

In order to eliminate the above shortcoming of poor flowability of the injected material in the mold, generally the injection pressure is increased for making the injected material fully flow into the gap between the core pins. However, the slender core pins have insufficient rigidity so that the excessively great injection pressure is very easy to bend and deform the core pin or even form a reverse hook at the end thereof. As a result, it becomes necessary to frequently service and replace the core pins and the cost is increased. Also, after demolded, the thickness of the rib between the terminal channels will become thinner and uneven.

### SUMMARY OF THE INVENTION

It is therefore a primary object of the present invention to provide a housing structure of a burn-in socket. Multiple densely and parallelly arranged core pins are respectively disposed the mold of the housing on two sides thereof. At least one filling member is plugged between the core pins. After molded, two lateral sides of the housing are formed with multiple densely arranged terminal channels separated from each other by ribs. A middle portion of each rib is formed with at least one notch. By means of plugging the filling member between the core pins, the flowability of the injected material flowing into the fine gaps between the core pins can be enhanced. Also, the injection pressure can be reduced to minimize damage of the mold.

It is a further object of the present invention to provide the above housing structure in which by means of plugging the filling member between the core pins, the rigidity of the core pins is enhanced to prevent the core pins from being bent and deformed so as to ensure precise width of the terminal channels and thickness of the ribs and thus ensure good quality of the product.

The present invention can be best understood through the following description and accompanying drawings wherein:

### BRIEF DESCRIPTION OF THE DRAWINGS

FIG. 1 is a perspective view of the housing of a conventional burn-in socket;

FIG. 2 is a perspective view of the housing structure of the present invention;

FIG. 3 is a top view of the housing structure of the present invention;

FIG. 4 is a sectional view taken along line A-A of FIG. 3;

FIG. 5 is a perspective exploded view of a complete burn-in socket of the present invention; and

FIG. 6 is a perspective assembled view of the complete burn-in socket of the present invention.

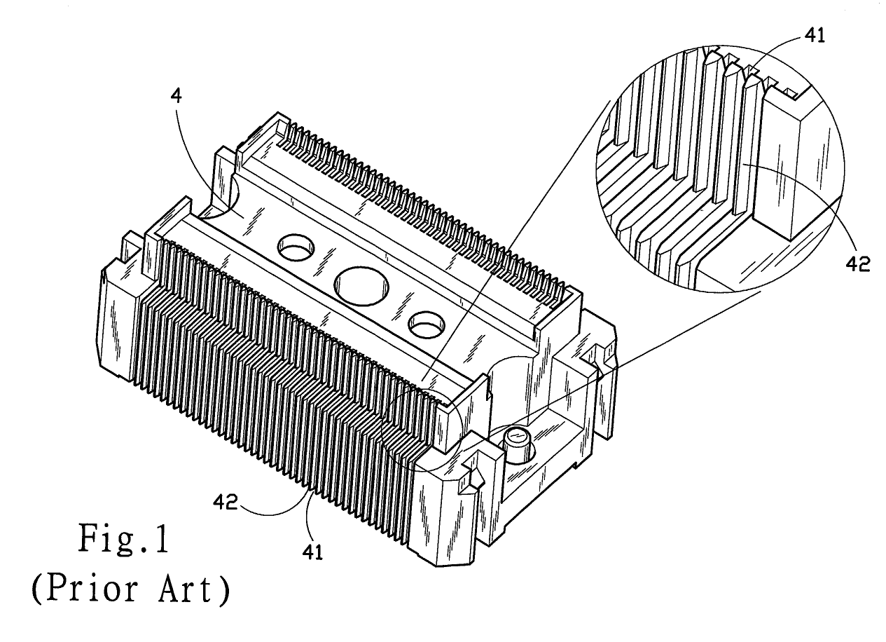

### DETAILED DESCRIPTION OF THE PREFERRED EMBODIMENT

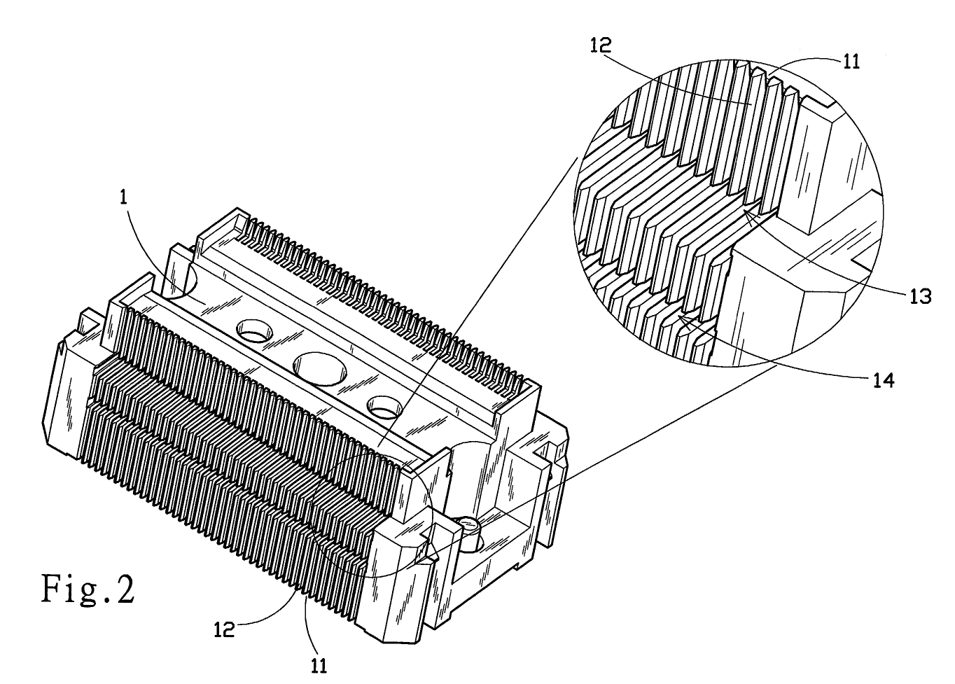

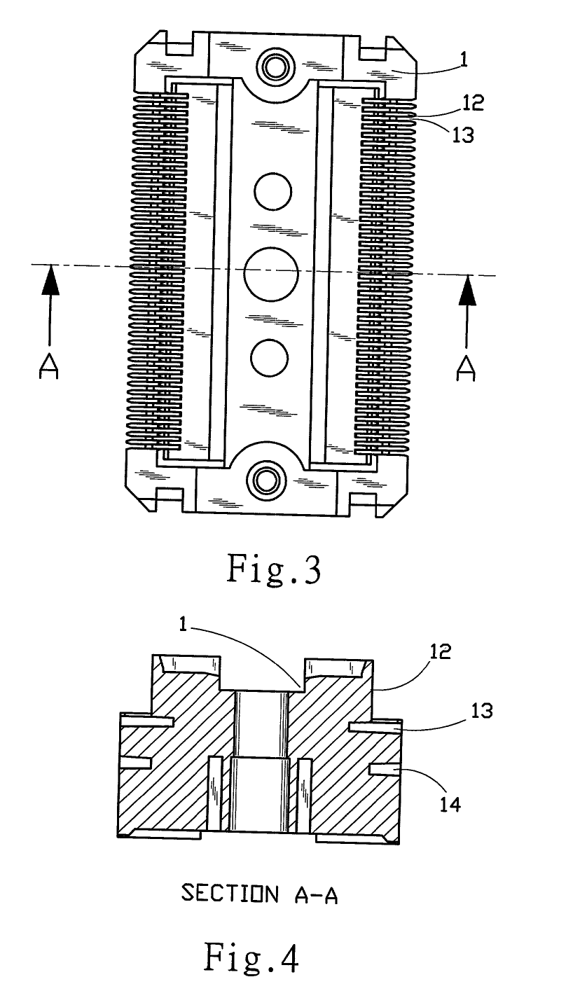

Please refer to FIGS. 2 to 4 which show the housing of the burn-in socket of the present invention. Two lateral sides of the housing 1 are respectively formed with multiple densely arranged terminal channels 11 separated from each other by ribs 12. The middle portion of each rib 12 is formed with multiple notches 13, 14 serially connected with each other.

Multiple parallel core pins are extended into the mold. After the material is injected and molded, the terminal channels 11 are formed in the positions of the core pins. The ribs 12 are formed in the gaps between the core pins. By means of plugging two filling members between the core pins, after molded, the notches 13, 14 will form on the ribs 12. The filling members are plugged between the core pins to effectively enhance the rigidity of the core pins and prevent the core pins from being bent and deformed. Therefore, the good quality of the housing can be ensured. Moreover, the flowability of the injected material flowing into the fine gaps between the core pins can be enhanced. Also, the injection pressure can be reduced to minimize damage of the mold.

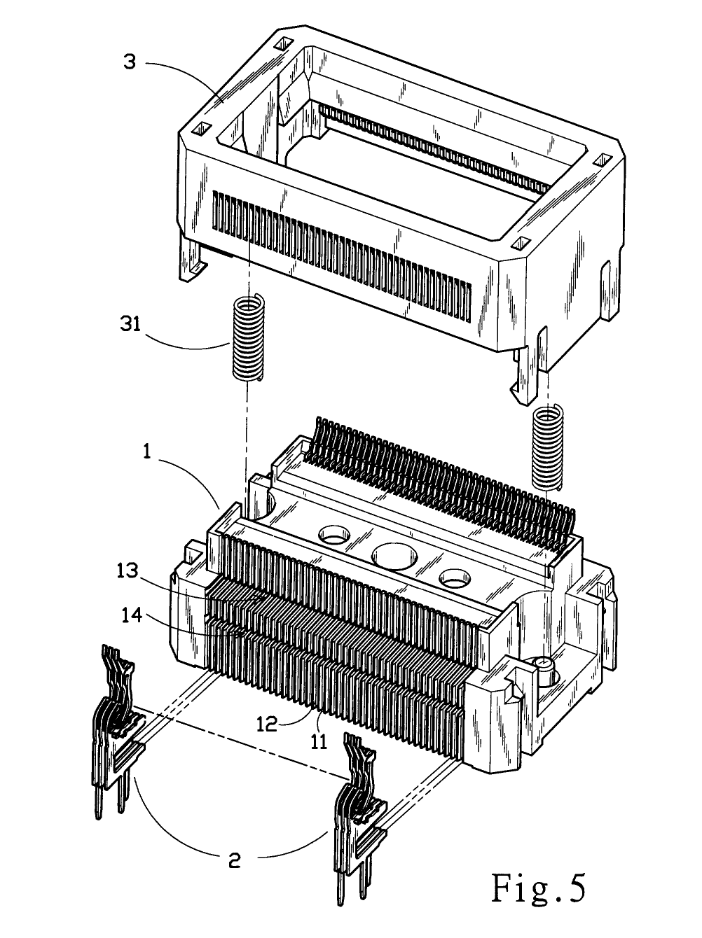

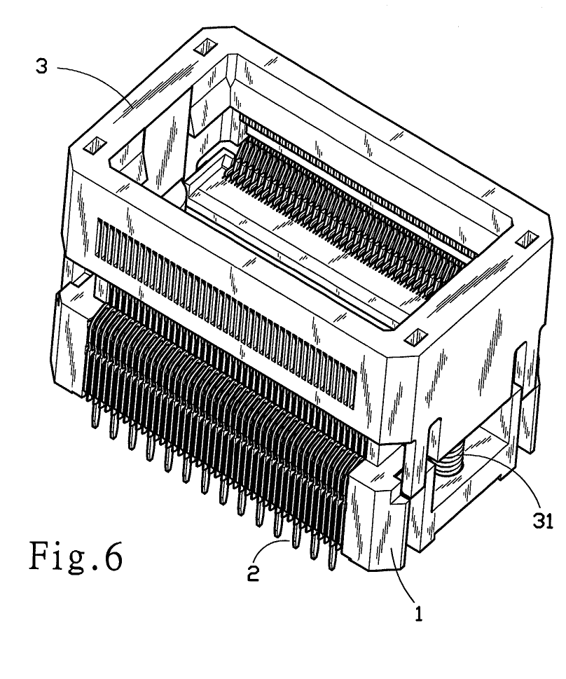

FIGS. 5 and 6 show a complete burn-in socket of the present invention. When inlaying the terminals 2 into the terminal channels 11 of the housing 1, the notches 13, 14 will not obstruct the terminals 2 or reduce the separating effect of the ribs 12 for the terminals 2. After the terminals 2 are inlaid and located in the terminal channels 11 of the housing 1, an upper cover 3 is fitted onto the housing 1 to cover the same. Multiple springs 31 are compressed between the housing 1 and the upper cover 3 to form a burn-in socket.

The above embodiment is only used to illustrate the present invention, not intended to limit the scope thereof. Many modifications of the above embodiment can be made without departing from the spirit of the present invention.

What is claimed is:

1. Housing structure of a burn-in socket, two lateral sides of the housing being respectively formed with multiple densely arranged terminal channels separated from each other by ribs, said housing structure being characterized in that when molded, a middle portion of each rib is formed with at least one notch extending from outer side to inner side.

2. Housing structure of a burn-in socket as claimed in claim 1, wherein the notches of the ribs are correspondingly serially arranged and connected with each other.

3. Housing structure of a burn-in socket as claimed in claim 1, wherein multiple parallel core pins are extended into the mold to form the terminal channels and the ribs are formed in the gaps between the core pins, by means of plugging a filling member between the core pins, after molded, the notches being formed on the ribs.
